(19) United States
(12) Patent Application Publication
(10) Pub. No.: US 2008/0124040 A1
(43) Pub. Date: May 29, 2008

(54) Vehicular audio/video expansion device provided with learning function and vehicular audio/video system

(75) Inventors: Ming-Feng Chen, Taipei (TW); Chia-Tzu Hu, Yunlin County (TW)

Correspondence Address: BACON & THOMAS, PLLC, 625 SLATERS LANE, FOURTH FLOOR, ALEXANDRIA, VA, 22314, US

(73) Assignee: ORIENTAL ELECTRONIC INDUSTRIAL CO., LTD, Taipei (TW)

(21) Appl. No.: 11/984,460

(22) Filed: Nov. 19, 2007

(30) Foreign Application Priority Data
Nov. 23, 2006 (TW) 095143310

(51) Int. Cl. H04N 5/91

(52) U.S. Cl. 386/46

(57) ABSTRACT

A vehicular audio/video expansion device provided with learning function, a vehicular audio/video system using the same and its learning method have been disclosed. According to the present invention, the vehicular A/V system comprises: a playback device having a remote control provided with a first button associated with a first control code for controlling the playback device when the first button is pressed; a host provided with a second button associated with a second control code; and an expansion device coupled to the host and the playback device. The expansion device processes the first control code and the second control code to generate a corresponding relation under a learning mode. According to the corresponding relation, the function of the first button is replaced by the second button to control the playback device under an operation mode.

### BACKGROUND OF THE INVENTION

1. Field of the Invention

The present invention relates to vehicular audio/video techniques, more particularly, this invention relates to an audio/video expansion device provided with learning function, a vehicular audio/video system using the same and its learning method.

2. Description of the Related Art

Traditionally, the shipping configuration of a car includes audio/video devices such as a stereo system and speakers. As the audio/video technology advances and users? demand on better audio/video experiences increases, an audio/video system is now become a popular option to vehicular users. The inventor of the present invention disclosed Vehicular Audio/Video Device and a Circuit of a Vehicular Audio/video Device for Integrating Auxiliary Input? in Taiwanese Utility Patent Number 225478. The vehicular audio/video device disclosed integrates a plurality of auxiliary inputs without alternating the hardware configuration of a conventional host system. A playback device for providing an auxiliary signal source often equips with a remote control for the user ease of use. However, when a user has several playback devices in use, the user is often confused by finding the correct remote control for the certain playback device. In addition, if a user is in a vehicle, the user is easily distracted by the extra effort required to match the remote control and the playback device and the user is at risk.

### SUMMARY OF THE INVENTION

It is therefore an objective of this invention to provide a vehicular audio/video expansion device with learning function, a vehicular audio/video system using the same and its learning method. The invention integrates the functions of buttons on one or a plurality of remote controls into the functions of buttons on a host so that a driver does not need to pay extra attention on matching the remote controls and playback devices and driver safety is protected.

In order to achieve the above purpose, the present invention provides a vehicular audio/video expansion device provided with learning function. The vehicular audio/video expansion device is coupled to the host and the playback device. The playback device comprises a remote control provided with a first button associated with a first control code for controlling the playback device when the first button is pressed. The host has a second button. The second button is associated with a second control code for the expansion device when the second button is pressed. The vehicular audio/video expansion device comprises a receiver for receiving the first control code, a controller coupled to the receiver and the host for processing the first control code and the second control code, and a memory coupled to the controller. The controller associates the first control code and the second control code to generate a corresponding relation and stores the corresponding relation in the memory under a learning mode. The controller generates a third control code for controlling the playback device according to the corresponding relation when the second button is pressed under an operation mode.

It is another objective of this invention to provide a vehicular audio/video system provided with learning function. The system comprises a playback device with a remote control, a host and an expansion device. The remote control provided with a first button associated with a first control code for controlling the playback device when the first button is pressed. The host provided with a second button associated with a second control code for the expansion device when the second button is pressed. The expansion device coupled to the host and the playback device. The expansion device processes the first control code and the second control code to generate a corresponding relation under a learning mode. The expansion device generates a third control code for controlling the playback device according to the corresponding relation when the second button is pressed under an operation mode.

It is another objective of this invention to provide a learning method for using a vehicular audio/video system. The learning method comprises: initiating a learning status; pressing a first button on a remote control to transmit a first control code for controlling a playback device; receiving the first control code at a expansion device; pressing a second button at a host to generate a second control code for the expansion device; and receiving the first control code an the second control code at the expansion device to generate a corresponding relation. The function of the first button is replaced by the function of the second button according to the corresponding relation.

### BRIEF DESCRIPTION OF THE DRAWINGS

FIG. 1 illustrates a block diagram of a preferred embodiment of a vehicular audio/video system according to the present invention;

FIG. 2 illustrates a flow chart of a preferred embodiment of a learning method with the vehicular audio/video system according to the present invention;

FIG. 3 illustrates a block diagram of an alternative preferred embodiment of a vehicular audio/video system according to the present invention;

FIG. 4 illustrates a block diagram of another alternative preferred embodiment of a vehicular audio/video system according to the present invention; and

FIG. 5 illustrates a detailed circuit diagram of a vehicular audio/video device with learning function according to the present invention.

### DETAILED DESCRIPTION OF THE PREFERRED EMBODIMENTS

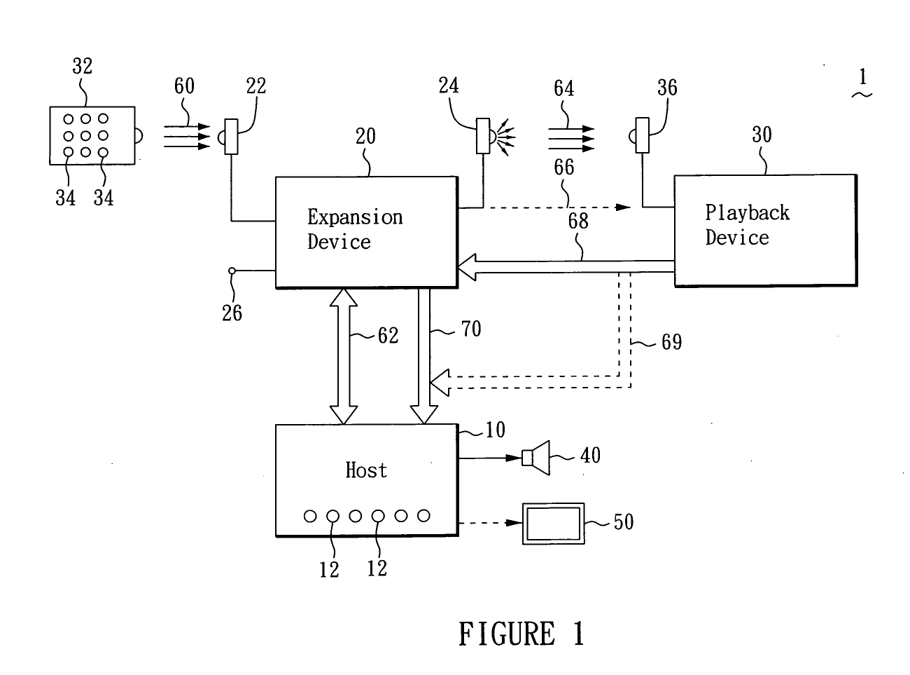

FIG. 1 illustrates a block diagram of a preferred embodiment of a vehicular audio/video system according to the present invention. In the vehicular audio/video system shown in FIG. 1, the vehicular audio/video system 1 comprises a host 10, an expansion device 20, a playback device 30 and at least one speaker 40.

The host 10 comprises an AM/FM tuner, a cassette player, an amplifier and audio process circuit such as a crossover. In addition to process the audio signals from the AM/FM tuner and the cassette player, the host 10 also processes audio signals from the signal wire 70 of the expansion device 20 or from the signal wire 69 of the playback device 30, then output the processed audio signals to the speaker 40. Alternatively, a host 10 is built in with a video display and a video process circuit for receiving and processing the video signals from the signal wire 70 of the expansion device 20 or from the signal wire 69 of the playback device 30. Alternatively, a host 10 is not build in with a video display and a video process circuit, then the video signals from the signal wire 70 of the expansion device 20 or from the signal wire 69 of the playback device 30 output to an external video display 50. Alternatively, a host is build in with a DVD player, VCD player, CD player or a MD player.

A playback device 30 is an audio signal source, an video signal source or an external audio/video mixed signal source, such as a detachable media storage device (for example, an MP3 player, MPEG-4 player, or an Apple iPod), a tuner, an analog TV box, digital TV box, a satellite receiver, a video cassette recorder/player, an karaoke machine, a DivX recorder/player, an HDMI player, a game console and a optical disc player. The optical disc player can be an audio player such as a CD player, and sometimes is an audio/video player such as a VCD player, or a DVD player. The playback device 30 transmits audio signals or video signals to the expansion device 20 via signal wire 68. The expansion device 20 transmits the audio signals or video signals to the host 10 via signal wire 70 for signal processing. If the expansion device 20 is connected to a single playback device 30, then the playback device 30 transmits the audio signals or video signals to the host 10 via signal wire 69 for signal processing directly.

The playback device 30 has a designated remote control 32. The remote control 32 is built with certain control buttons 34 for controlling operations of the playback device 30. If the playback device 30 is a digital TV receiver, the buttons 34 on the remote control 32 can be the buttons H+? or H−? for channel selections. The remote control 32 transmits corresponding control code 60 when H+? or H−? is pressed. The receiver 36 installed at the playback device 30 receives the control code 60 for controlling the channel selection of the digital TV receiver. The signals transmitted from the remote control 32 to the playback device 30 can be infrared (IR) signals or radio frequency (RF) signals.

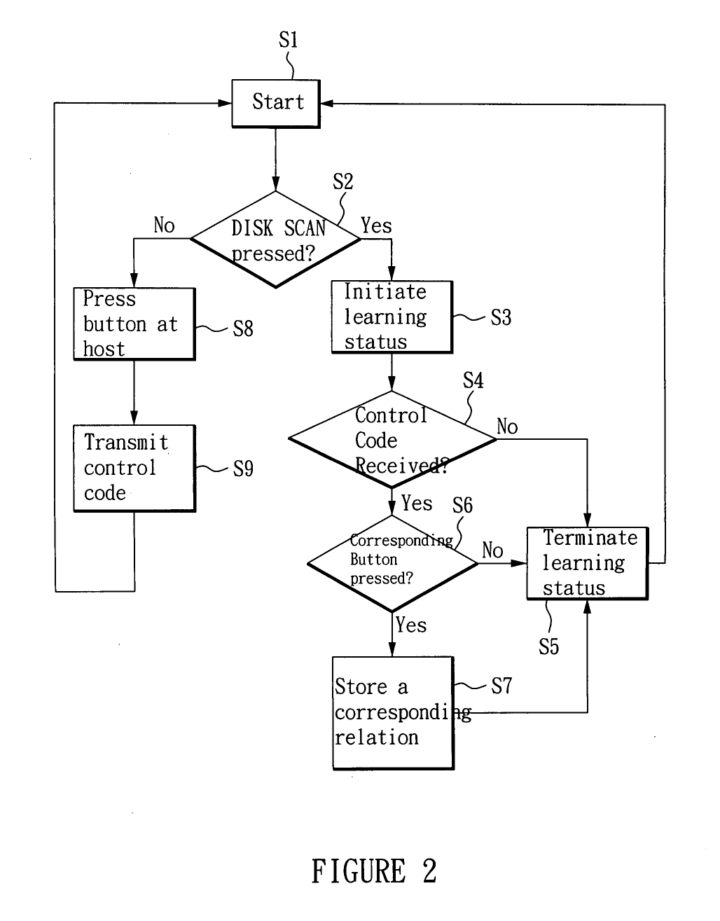

The objective of the present invention is to replace the button 34 on the remote control 32 with the button 12 on the host 10 by performing the learning operations at the expansion device 20. The learning method makes the function of the button 34 on the remote control 32 associated with the function of the button 12 on the host 10. Upon the learning method completes, the button 12 on the host 10 replaces the button 34 on the remote control 32 and the button 12 control the playback device 30 directly. The learning method is detailed in FIG. 2. Referring to FIG. 1 and FIG. 2, the playback device 30 being a digital TV is exemplified to demonstrate steps of the learning method to replace the buttons H+? and H−?

As shown in FIG. 2, the step S1 is the beginning of the leaning method and the step S2 is the judgment step on if a user presses the learning initiation button. In the preferred embodiment, the DISK SCAN button on the host 10 is predefined as the learning initiation button. At the S2, the user decides if the DISK SCAN button on the host 10 is pressed or not. If the judgment is yes, then the learning moves to the step S3 to initiate the learning status of the remote control 32. The step S4 is a judgment on if the remote control 32 receives the control code 60 after the learning status initiated. If the remote control 32 does not receive the control code 60, which means the user does not press the button 34 on the remote control 32, the learning moves to the step S5 to terminate the learning status of the remote control and return to the step S1. If the user presses the button 34 on the remote control 32, which means at the step S4 the receiver 22 of the expansion device 20 receives the control code 60, the learning moves to the step S6. The step S6 is a judgment on if the corresponding button 12 is pressed on the host 10 and corresponding control code is transmitted to the expansion device 20 via control wire 62. If the button 12 is not pressed on the host 10 at the step S6, then the learning moves to the step S5 to terminate the learning status of the remote control. If the button 12 is pressed at the step S6, then the learning moves to the step S7, the control code transmitted by the control wire 62 is linked to the control code 62 from the remote control 32. For example, the expansion device 20 links the function of the button pressed on the remote control 32, the H+? button, to the function of the button pressed on the host 10, the SEEK/TRACK UP button by establish a corresponding relation of the control codes. The expansion device 20 stores the corresponding relation and then the learning method moves to S5.

At the step S2, if the DISK SCAN button is not pressed, then the learning moves to a operation mode, where the button 12 on the host 10 replaces the button 34 on the remote control 32. It follows that at the step S8, the control code is transmitted to the expansion device 20 via the control wire 62 after pressing the button 12 such as a SEEK/TRACK UP button on the host 10. According to the corresponding relation stored at the expansion device 20, the control code from the host 10 corresponds to the button CH+ on the remote control 32. A transmitter 24 on the expansion device 20 transmits the control code 64 corresponding to the button CH+ to the playback device 30. The receiver 36 on the playback device 30 receives the control code 64 such that he playback device 30 adjusts the audio or video signals according to the control code 64. The audio or video signals then are transmitted to the expansion device 20 via the signal wire 68 or output to the host 10 via the signal wire 69. The signal transmission used between the expansion device 20 and the playback device 30 can be IR or RF signaling. As shown in FIG. 1, if the expansion device 20 is connected to the playback device 30 with a control wire 66, then the control codes 64 can be transmitted via the control wire 66 and the transmitter 24 can be waived.

Furthermore, when the expansion device 20 is installed with a learning initiation button or initiation control wire as shown in the reference numeral 26 in FIG. 1, the step S2 shown in the FIG. 2 is a judgment step on if the learning method is initiated by pressing initiation button is pressed or enabling the initiation control wire at the expansion device 20.

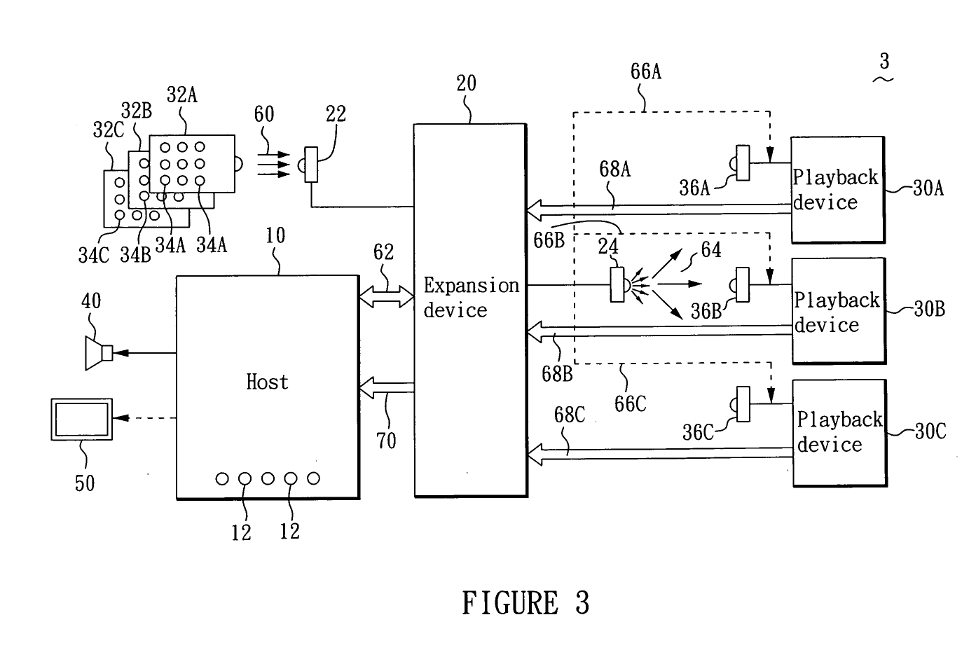

FIG. 3 illustrates a block diagram of an alternative preferred embodiment of a vehicular audio/video system according to the present invention. As shown in the FIG. 3, the vehicular audio/video system comprises a host 10, an expansion device 20, a plurality of playback device 30A, 30B, 30C and a speaker 40.

The host 10 comprises an AM/FM tuner, a cassette player, an amplifier and audio process circuit such as a crossover. In addition to process the audio signals from the AM/FM tuner and the cassette player, the host also processes audio signals from a signal wire 70 of the expansion device 20, and then output the processed audio signals to the speaker 40. Alternatively, a host 10 is built in with a video display and a video process circuit for receiving and processing the video signals from the signal wire 70 of the expansion device 20. Alternatively, a host 10 is not build in with a video display and a video process circuit, then the video signals from the signal wire 70 of the expansion device 20 output to an external video display 50. Alternatively, the host 10 can be build in with a DVD player, VCD player, CD player or a MD player.

A plurality of playback devices 30A, 30B, and 30C are audio signal source, video signal source or external audio/video mixed signal source, such as an detachable media storage device (for example, an MP3 player, MPEG-4 player, or an Apple iPod), a tuner, an analog TV box, digital TV box, a satellite receiver, a video cassette recorder/player, an karaoke machine, a DivX recorder/player, an HDMI player, a game console and an optical disc player. The optical disc player can be an audio player such as a CD player, and sometimes is an audio/video player such as a VCD player, or a DVD player. The playback devices 30A, 30B, and 30C transmits audio signals or video signals to the expansion device 20 via signal wire 68A, 68B, and 68C. The expansion device 20 selects one input among 68A, 68B, and 68C, and then transmits the audio signals or video signals selected to the host 10 via the signal wire 70 for following signal processing. In the present preferred embodiment, three playback devices 30A, 30B and 30C are utilized as one example, the applications according to the invention is not limited by the embodiment. Preferred embodiments may apply two, four or multiple playback devices as the embodiments fit.

The playback device 30A, 30B and 30C have a designated remote controls 32A, 32B and 32C. The remote controls 32A, 32B and 32C are built with certain control buttons 34A, 34B and 34C for controlling operations of the playback devices 30A, 30B and 30C. When the playback device 30A is a digital TV receiver, the buttons 34A on the remote control 32A are the buttons H+? or H−? for channel selections. The remote control 32A transmits corresponding control code 60 when H+? or H−? is pressed. The receiver 36A installed at the playback device 30A receives the control code 60 for controlling the channel selection of the digital TV receiver. The signals transmitted from the remote control 32A to the playback device 30A are infrared (IR) signals or radio frequency (RF) signals.

The aim of the present invention is to replace the button 34A, 34B, and 34C on the remote control 32A, 32B and 32C with the button 12 at the host 10 by performing the learning operations at the expansion device 20. The learning method connects the function of the button 34A, 34B, and 34C on the remote control 32A, 32B and 32C with the function of the button 12 on the host 10. Upon the learning method completes, the button 12 on the host 10 replaces the buttons 34A, 34B, and 34C on the remote controls 32A, 32B and 32C and the button 12 control the playback device 30 directly. The learning method is detailed in FIG. 2.

As shown in FIG. 3, after the learning method completes, a transmitter 24 at the expansion device 20 transmits corresponding control code 64 to the playback device 30A, 30B or 30C. The receiver 36A, 36B or 36C at the corresponding playback device 30A, 30B or 30C receives the control code 64. One of the playback device 30A, 30B and 30C adjusts the audio or video signals according to the control code 64 and transmits the signals to the to the expansion device 20 via one of the signal wire 68A, 68B and 68C.

The signals transmission used between the expansion device 20 and the playback device 30A, 30B and 30C can be IR or RF signals. As shown in FIG. 3, if the expansion device 20 is connected to the playback device 30A, 30B and 30C with a control wire 66A, 66B and 66C respectively, then the control codes can be transmitted via the control wire 66A, 66B or 66C such that the transmitter 24 can be waived.

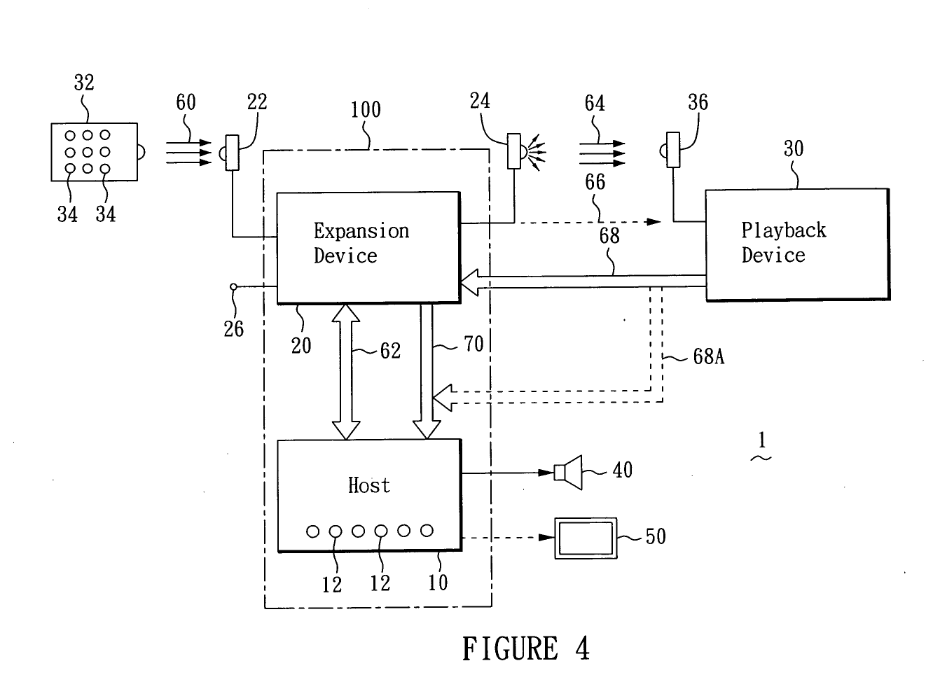

FIG. 4 illustrates a block diagram of another alternative preferred embodiment of a vehicular audio/video system according to the present invention. As compared FIG. 4 with FIG. 1, the expansion device and the host 10 are integrated to be a single host 100 in the preferred embodiment disclosed in the FIG. 4. The rest of the configuration disclosed in the preferred embodiment shown in the FIG. 4 is similar to the preferred embodiment shown in the FIG. 1 and thus is not repeated here.

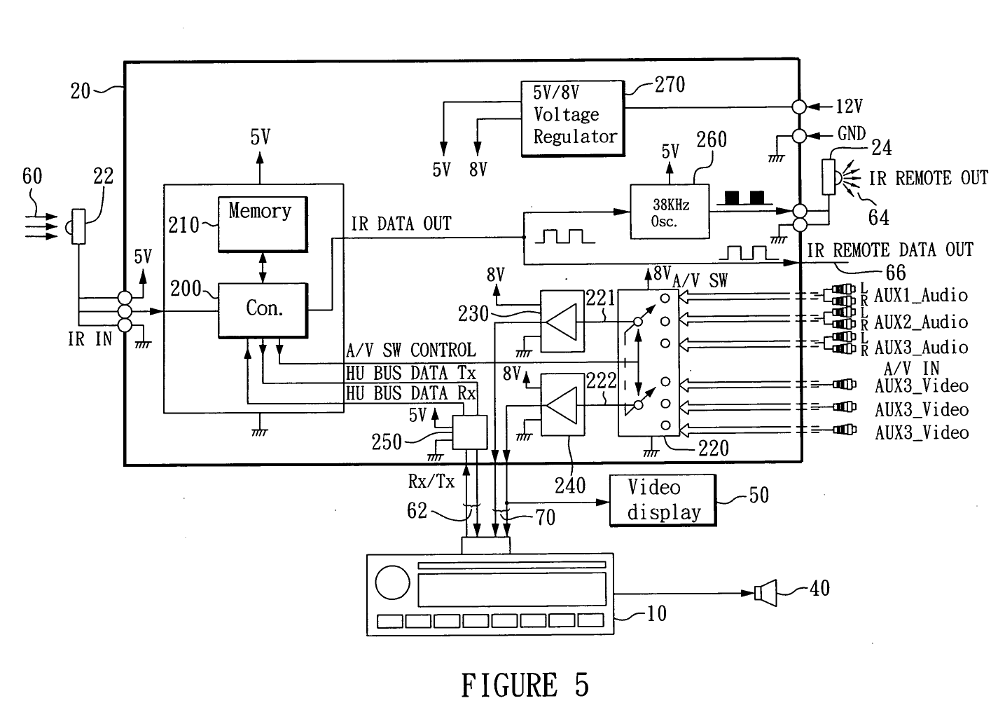

FIG. 5 illustrates a detailed circuit diagram of a vehicular audio/video device 20 with learning function according to the present invention. As shown in FIG. 5, the expansion device 20 has a micro controller 200, a control code memory 210 and a signal switch 220. The micro controller 200 controls operations of expansion device 20. The control code memory 210 is coupled to the micro controller 200 for storing a corresponding relation between the button 34 on the remote control 32 and the button 12 on the host 10. The signal switch 220 is coupled to the micro controller 200 for switching the plural auxiliary inputs (AUX1_Audio/AUX1_Video, AUX2_Audio/AUX2_Video, AUX3_Audio/AUX3_Video) from three playback devices shown in the FIG. 5. Further, the audio output terminal 221 of the signal switch 220 is coupled to an audio buffer 230 and the video output terminal 222 of the signal switch 220 is coupled to a video buffer 240. The output terminals of audio buffer 230 and video buffer 240 connected to the host 10 form the signal wire 70.

As shown in FIG. 5, the control wire 62 between the host 10 and the expansion device 20 has a bus buffer 250. In details, the bus buffer 250 is provided between the micro controller 200 and the host 10. The receiver 22 and the transmitter 24 are coupled to the micro controller 200 for receiving the control code 60 and transmitting the control code 64. If the transmitter 24 is an infrared transmitter, then an oscillator 260 of 38 KHz is installed between the micro controller 200 and the transmitter 24. Alternatively, the oscillator of 38 KHz can be replaced by generating 38 KHz oscillating frequency by running software or firmware at the micro controller 200. As described previously, the expansion device 20 may transmit control code directly via the control wire 66 and as a result the transmitter 24 can be waived. A voltage regulator. 270 is provided for transforming the 12V DC to 5V DC or 8V DC as the power source of the expansion device 20.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A vehicular audio/video expansion device provided with learning function, coupled to a host and a playback device; the playback device having a remote control provided with a first button associated with a first control code for controlling the playback device when the first button is pressed; the host having a second button associated with a second control code for the expansion device when the second button is pressed; the vehicular audio/video expansion device comprises:
a receiver for receiving the first control code;
a controller coupled to the receiver and the host for processing the first control code and the second control code, and
a memory coupled to the controller, wherein the controller associates the first control code with the second control code to generate a corresponding relation and stores the corresponding relation in the memory under a learning mode, and wherein the controller generates a third control code for controlling the playback device according to the corresponding relation when the second button is pressed under an operation mode.

2. The vehicular audio/video expansion device of claim 1, further comprising a transmitter for transmitting the third control code to the playback device.

3. The vehicular audio/video expansion device of claim 1, further comprising a control wire for transmitting the third control code to the playback device.

4. The vehicular audio/video expansion device of claim 1, further comprising a bus buffer coupled to the controller and the host for processing the second control code.

5. The vehicular audio/video expansion device of claim 1, wherein the remote control is an infrared remote control.

6. The vehicular audio/video expansion device of claim 5, wherein the receiver is an infrared receiver.

7. The vehicular audio/video expansion device of claim 1, wherein the remote control is a radio frequency remote control.

8. The vehicular audio/video expansion device of claim 7, wherein the receiver is a radio frequency receiver.

9. A vehicular audio/video system provided with learning function comprising:
a playback device comprises a remote control provided with a first button associated with a first control code for controlling the playback device when the first button is pressed
a host provided with a second button associated with a second control code for the expansion device when the second button is pressed; and
an expansion device coupled to the host and the playback device, wherein the expansion device processes the first control code and the second control code to generate a corresponding relation under a learning mode, and wherein the expansion device generates a third control code for controlling the playback device according to the corresponding relation when the second button is pressed under an operation mode.

10. The vehicular audio/video system of claim 9, wherein the expansion device comprises:
a receiver for receiving the first control code,
a controller coupled to the receiver and the host for processing the first control code and the second control code, and
a memory coupled to the controller, wherein the controller associates the first control code and the second control code to generate a corresponding relation and stores the corresponding relation in the memory under the learning mode, and wherein the controller generates the third control code for controlling the playback device according to the corresponding relation when the second button is pressed under the operation mode.

11. The vehicular audio/video system of claim 10, further comprising a transmitter for transmitting the third control code to the playback device.

12. The vehicular audio/video system of claim 10, further comprising a control wire for transmitting the third control code to the playback device.

13. The vehicular audio/video system of claim 10, further comprising a bus buffer coupled to the controller and the host for processing the second control code.

14. The vehicular audio/video system of claim 10, wherein the remote control is an infrared remote control.

15. The vehicular audio/video system of claim 14, wherein the receiver is an infrared receiver.

16. The vehicular audio/video system of claim 10, wherein the remote control is a radio frequency remote control.

17. The vehicular audio/video system of claim 16, wherein the receiver is a radio frequency receiver.

18. The vehicular audio/video system of claim 9, wherein the host and the expansion device is integrated into a single device.

19. A learning method for using a vehicular audio/video system comprises:
initiating a learning status;
pressing a first button on a remote control to transmit a first control code which can be used to control a playback device;
receiving the first control code at a expansion device;
pressing a second button at a host to generate a second control code for the expansion device; and
receiving the first control code and the second control code at the expansion device to generate a corresponding relation, wherein the function of the first button is replaced by the function of the second button according to the corresponding relation.

20. The learning method of claim 19, wherein a predefined button on the host is pressed to initiate the learning status.

21. The learning method of claim 19, wherein a predefined button on the expansion device is pressed to initiate the learning status.

22. The learning method of claim 19, wherein the initiating control wire is enabled to initiate the learning status.
